(19) United States
(12) Patent Application Publication
(10) Pub. No.: US 2005/0018240 A1
(43) Pub. Date: Jan. 27, 2005

(54) Output control device

(76) Inventors: Toshihiro Shima, Nagano-ken (JP); Teruhito Kojima, Nagano-ken (JP)

Correspondence Address: MARTINE & PENILLA, LLP, 710 LAKEWAY DRIVE, SUITE 170, SUNNYVALE, CA, 94085, US

(21) Appl. No.: 10/859,664

(22) Filed: Jun. 2, 2004

(30) Foreign Application Priority Data
Jun. 5, 2003 (JP) 2003-160869

(51) Int. Cl. G06F 15/00

(52) U.S. Cl. 358/1.15; 358/1.1; 358/1.13

(57) ABSTRACT

A local area network is constructed to which are connected multiple clients CL1 to CL3 and printer PRT1. Printer PRT1 comprises two print job receiving ports, Port 9100 and Port 29100. When client CL1 sends print job JOB0 specifying the port of Port 29100, printer PRT1 correlates the print job received at the receiving port of Port 29100 with the IP address IP10 of the send source client CL1, and reserves the print job. When the print execution instructions are received from client CL1, the print job to be printed is specified as print job JOB0. When it is detected that the user has operated operating panel OP, printing of print job JOB0 is executed.

### BACKGROUND OF THE INVENTION

1. Field of the Invention

The present invention relates to technology for controlling a printing process at a printing device connected to a network.

2. Description of the Related Art

In recent years, there has been popularization of printing modes whereby print jobs are sent to a printing device from a client connected on a network such as a local area network (LAN). In the past, printing jobs received on a network ensured security using, for example, security technology such as encoding processing to avoid information leaks, or authentication between the client that receives the print job and the printing device to avoid falsification by a third party of print job contents.

However, even when the security of print jobs is secured using technology like that described above, at the point that the printed item is output, it is difficult to avoid the risk of things such as being stolen by a third party.

### SUMMARY OF THE INVENTION

The present invention was created considering the problems described above, and its goal is to avoid stealing or illicit reading of printed items.

To solve at least part of the problems described above, a first aspect of the present invention is to provide an output device that executes output processing using data received from a data sending device that is connected to a network. The output device of the first aspect of the present invention is summarized in that it comprises a data receiving unit that receives said data from said data sending device, a printing reserve unit that reserves said data in a state with said data sending device correlated to specifiable device specification information, an instruction receiving unit that receives execution instructions including said machine specification information from said data sending device, a data specification unit that specifies data to be output from said reserved data based on said device specification information, a detection unit that detects user operations on said output device after receiving said execution instructions, and an output unit that executes output processing of said specified data based on said operation detection.

The output device can be assumed to be a variety of devices, for example, a projector or display, a printing device, a facsimile machine, or an acoustic system, etc.

With the output device of the first aspect of the present invention, since output is executed with the performance of an operation directly by the user on the output device as the trigger, it is possible to try to increase convenience by being able to perform output at the desired timing of the user.

The second aspect of the present invention provides a printing device that executes print jobs received from a print job issuing device that is connected to a network. The printing device of the second aspect comprises job receiving unit that receives said print jobs from said print job issuing device, a print reserve unit that reserves said print jobs in a state whereby said print job issuing device is correlated to specifiable device specification information, an instruction receiving unit that receives execution instructions including said device specification information from said print job issuing device, a print job specification unit that specifies a print job to be executed from said reserved reserve print jobs based on said device specification information, a detection unit that detects user operations on said printing device after receiving said execution instructions, and a print execution unit that executes said specified print jobs based on said operation detection.

With the printing device of the second aspect of the present invention, the printing of the received print job is reserved, and printing is executed with a direct operation by the user performed on the printing device as the trigger, so it is possible to output a printed item in a state for which there is a high possibility that the user is in a place near the printing device. It is also possible to avoid stealing and illicit reading of the output printed material by a third party other than the user.

For the printing device of the second aspect of the present invention, it is also possible to comprise a mode instruction receiving unit that receives from the job issuing device the mode instruction that reserves execution of the received print job and instructs the storage mode that stores said print job, and a mode control unit which, after the mode instruction is received, operates the print reserve unit, instruction receiving unit, print job specification unit, detection unit, and print execution unit for the print job sent from the print job issuing device. In this case, after receiving mode shifting instructions from the print job issuing device, if execution of the concerned print job sent from the print job issuing device is reserved and stored, for the print job, print jobs sent from other print job issuing devices will be printed as normal, so it is possible to divide use of the storage mode and normal mode, which makes it possible to increase convenience.

The printing device of the second aspect of the present invention can further comprise a print processing unit that expands a specified print job into data for which printing can start regardless of the operation detection. If this is done, when user operation is detected on the printing device, it is possible to output the printed item immediately, making it possible to shorten printing time, and to improve convenience.

Also, the instruction receiving unit preferably further sets the printing device operation status to offline after receiving execution instructions. In such a case, the execution instructions can include offline setting information and can go offline by receiving execution instructions.

The user can execute printing easily by resetting from offline to online using the panel operation, for example.

Also, the detection unit can have a time restriction provided for user operation detection. When an operation is not detected within the restricted time, printing can be cancelled, and the printing job can be deleted, or the print job can be reserved as is with only the execution instructions invalidated. In the latter case, there is the advantage of being able to execute printing simply by resending the execution instructions without going so far as to resend the print job.

As described above, by going offline, it is possible to not receive execution instructions from the print job execution device other than the specified print job, but it is also possible to have the instruction receiving unit reject execution instructions from after the execution instructions are received until an operation is detected. This is useful because by doing this, it is possible to avoid receiving execution instructions simultaneously from two or more users.

A third aspect of the present invention provides an output control device that controls an output device connected to a network. The output control device of the third aspect of the present invention comprises a reserve unit that reserves said data output based on output instructions from the user, a detection unit that detects changes in operating status based on operation by said user on said output device, and an instruction unit that sends execution instructions to execute said output based on said change detection.

With the output control device of the third aspect of the present invention, with direct operation by the user on the output device as a trigger, it is possible to perform output on a desired output device at a desired timing and to try to improve convenience.

A fourth aspect of the present invention provides a print control device that controls printing of print jobs on a printing device connected to a network. The print control device of the fourth aspect of the present invention is summarized by comprising a reserve unit that reserves execution of said print job based on printing instructions from the user, a detection unit that detects changes in operating status based on operation by said user on said printing device, and a printing instruction unit that sends execution instructions to have said printing executed.

The operating status based on the user operation can be detected using an SNMP, for example. It is also possible to broadcast SNMP packets with a command to get operation status attached from the print control device, or to perform a unicast or multicast to a specific printing device. It is also possible to have the operating status of a printing device on a network detected at a designated timing regardless of print processing, or to detect at a designated time after receiving printing instructions. It is also possible to cancel the reserved printing job when it is not possible to detect changes in the operating status for any of the printing devices on the network within the designated time.

With the printing device of the fourth aspect of the present invention, after receiving printing instructions from the user, changes in operating status by user operation are detected, and execution instructions are sent. Because of this, in a state with the user in an area near the printing device which is the output destination of the print job, it is possible to execute printing at the printing device, making it possible to avoid stealing or illicit reading of the output printed item by a third party other than the user.

The reserve unit of the fourth aspect of the present invention can also send printing reserve instructions to reserve execution of said print job after sending a print job to a printing device. By doing this, it is possible to reserve execution of the print job at the printing device. If the print reserve instructions are made to include instructions to set the printing device operating status to offline, after that, it is possible to have receiving of the print job sent to the printing device from another machine on the network unnecessary.

It is also possible to have the reserve unit reserve print jobs. In this case, it is possible to specify the printing device for which changes in operating status are detected as the print job sending destination, and realization can be achieved by the printing instruction unit sending print jobs including execution instructions to the printing device specified as the print job sending destination. By doing this, a user can send a print job and execute printing at a desired timing of the user to a desired printing device with the user nearby, so this improves the level of convenience. It is also possible to have the user perform operation on multiple printing devices and to realize parallel printing. In this case, from a security standpoint for the output printed items, it is preferable to have each of the printing devices for which parallel printing is performed be near each other.

For the print control device of the fourth aspect of the present invention, it is possible to send print jobs in advance together with print reserve instructions to multiple printing devices, and for all printing devices for which changes in operating status by the user is detected, to have the print job executed. In this case, after the print job is sent, it is possible to have printing devices monitored for detection of changes in operating status for a designated time, for example 30 seconds, and for those for which change is not detected, to judge these as not being specified as output destinations. Also, if printing based on a print job sent to a printing device is cancelled, it is possible to avoid having print jobs being at a printing device for long periods of time. With a print job kept in reserved status, it is also possible to execute printing by performing a separate designated operation without canceling printing.

Also, for the print control device of the fourth aspect of the present invention, it is possible to further comprise an encoding processing unit that encodes the print job and sends it to the printing device. Encoding can include, for example, a public key encoding method or a common key encoding method, etc. In this case, it is possible to prepare an encoding and decoding key between the print control device and printing device in advance to perform encoding processing. It is also possible to create a one time password that can be used only once on the printing device side, for example, and to send this to the print control device. By doing this, it is possible to further improve print job security, which is optimal.

For the present invention, in addition to the structure using the output device, printing device, output control device, and print control device described above, it is also possible to have a structure of the invention of an output control method that controls an output device connected to a network, a method of controlling the printing of a print job using the print control device, an output method that controls data output using the output device, and a printing method that performs printing using the printing device. It is also possible to implement various aspects with a computer program that realizes the output control and print control described above, a recording medium that records that program, and including that program, data signals that are realized within a carrier wave. It is possible to apply the various types of additional elements shown above to various aspects.

When structuring the present invention using a computer program or the recording medium that records this program, etc., it is possible to construct this such that the entire program controls the printing device, or to construct only a part that achieves the function of the present invention. Also, as the recording medium, it is possible to use various media which can be read by a computer such as flexible disks, CD-ROMs, DVD-ROMs, punch cards, printed items on which code such as a bar code is printed, an internal recording device of the computer (ROM or memory such as ROM), or an external recording medium.

### BRIEF DESCRIPTION OF THE DRAWINGS

FIG. 1 is an explanatory diagram that shows the configuration of the printing system for the first embodiment.

FIG. 2 is an explanatory diagram that shows a configuration example of the operating panel for the first embodiment.

FIG. 3 is an explanatory diagram that shows functional blocks of the printer of the first embodiment.

FIG. 4 is a flow chart that explains the printing process of the first embodiment.

FIG. 5 is an explanatory diagram that shows an example of the instruction screen for sending print execution instructions for the first embodiment.

FIG. 6 is an explanatory diagram that shows the configuration of the printing system for the second embodiment.

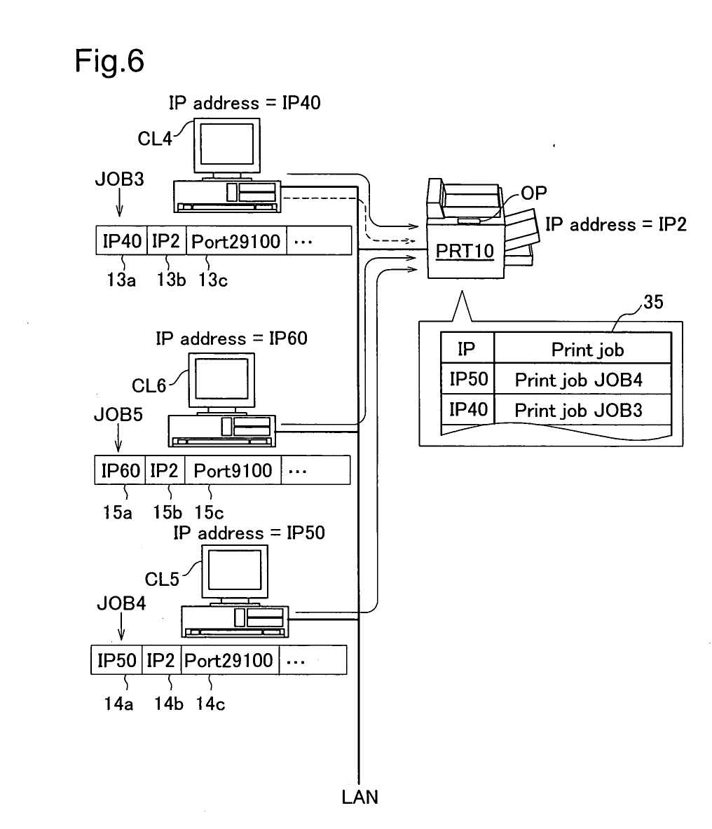

FIG. 7 is an explanatory diagram that shows functional blocks of the printer of the second embodiment.

FIG. 8 is a flow chart explains the printing process of the second embodiment.

FIG. 9 is a flow chart that explains the print job specification process for the second embodiment.

FIG. 10 is an explanatory diagram that shows the configuration of the printing system for the third embodiment.

FIG. 11 is an explanatory diagram that shows the functional blocks of print control device 100 for the third embodiment.

FIG. 12 is a flow chart that explains the printing process of print control device 100 for the third embodiment.

FIG. 13 is a flow chart that explains the printer specification process for the third embodiment.

FIG. 14 is a flow chart that explains the printing process of the printer for the third embodiment.

FIG. 15 is a flow chart that explains the printing process for the variation example.

### DETAILED DESCRIPTION OF THE PREFERRED EMBODIMENTS

Following, we will explain the present invention based on several embodiments while referring to figures.

### A. First Embodiment

A1. System Summary:

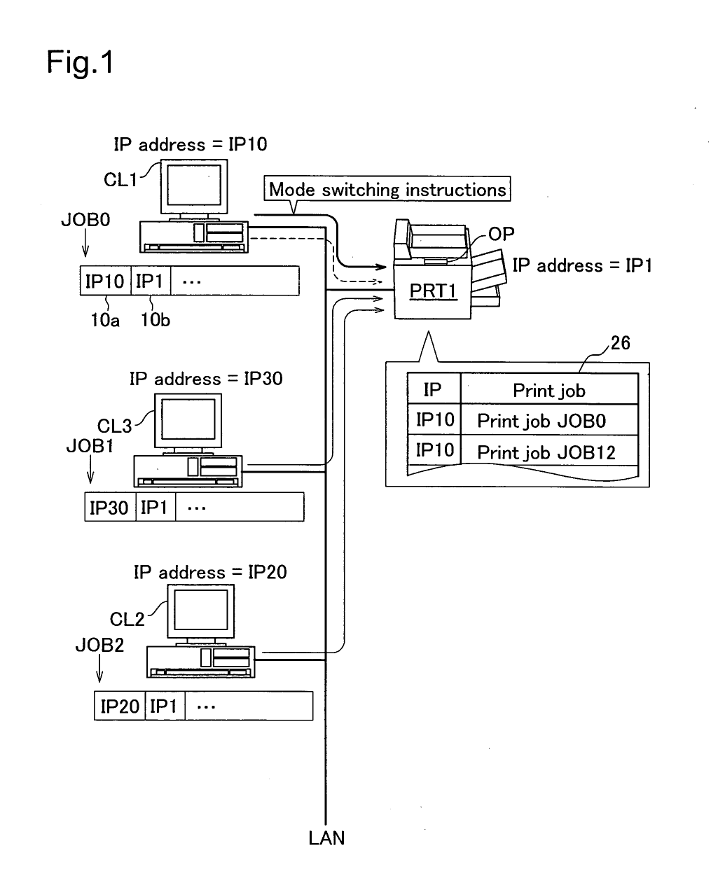

FIG. 1 is an explanatory diagram that shows the structure of a printing system as the first embodiment. With this embodiment, as shown in the figure, multiple clients CL1 to CL3 and printer PRT1 are connected to a local area network LAN. For the IP address of each machine, for purposes of explanation, IP10 to IP30 are respectively set for clients CL1 to CL3, and IP1 is set for printer PRT1.

Printer PRT1 comprises a storage mode that stores received print jobs in a reserved state and a non-storage mode that executes received print jobs as is, and during normal use, this is set to non-storage mode, and this moves to the storage mode when mode switching instructions are received from the user. The storage mode is realized between the client to which is sent the concerned mode switching instructions and the printer which received instructions, and print jobs from other clients are executed in the normal fashion.

As shown by the bold arrow in the figure, for client CL1, before sending of print job JOB0, mode switching instructions to shift printer PR1 from non-storage mode to storage mode are sent. When printer PR1 receives the concerned instructions, it shifts to the storage mode, and after that, storage is done in a state with reserving of the execution of print jobs received from the instruction sending source client.

Clients CL1 to CL3 respectively send print jobs JOB0 to JOB2 to printer PRT1. Included in print jobs JOB0 to JOB2 are, in addition to the print data to be printed, sending source IP addresses 10a to 12a and sending destination IP addresses 10b to 12b the print job that has the send source IP address IP10, in other words, the print job JOB0 sent from client CL1, stored in print job reserve unit 26 in a print reserved state. Print jobs sent from clients other than IP address IP10 are left in the state of being in the non-storage mode, so are executed as is.

When the client CL1 user executes printing, it sends printing execution instructions that include its own IP address IP10 to PRT1 as shown by the dotted line in the figure. When printer PRT1 receives printing execution instructions, the print job reserved at print job reserve unit 26 is analyzed, and is expanded to a printable state while at the same time the operating status is set to offline. Printer PRT1 detects that operating panel OP was operated and that the operating status changed to online, and executes printing of print job JOB0. With this embodiment, we described sending mode switching instructions only from client CL1, but it is also possible to send mode switching instructions in the same way from another client and to perform printing processing in the storage mode. In such a case, realization is easy by specifying a print job to be executed from the IP address of the client that sent the printing execution instructions.

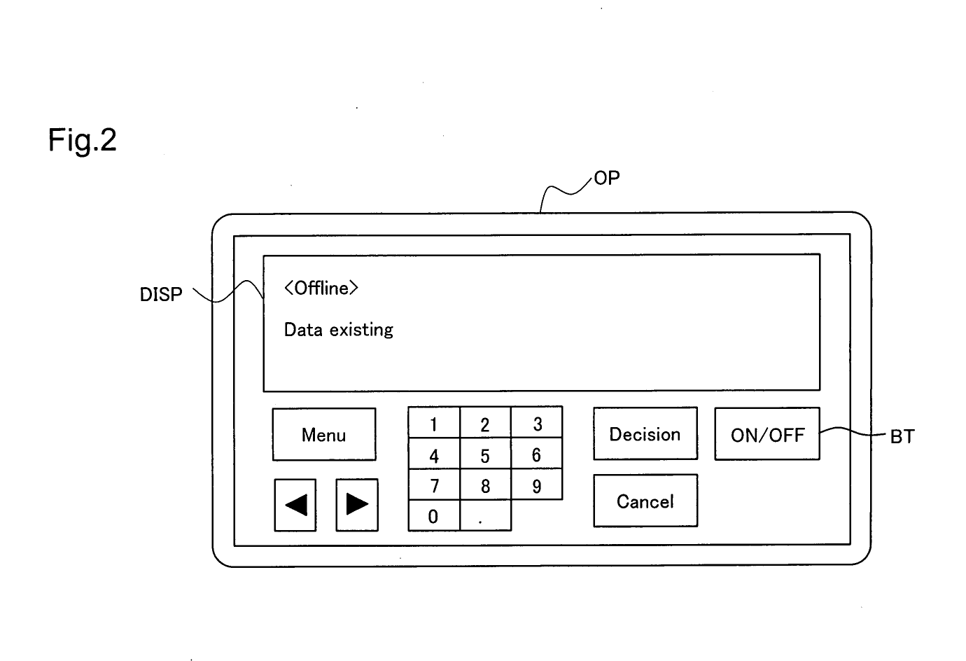

FIG. 2 is an explanatory diagram that shows a structural example of an operating panel. Provided on operating panel OP are display DISP and various buttons including button BT for operating switching between online and offline. Display DISP is an LCD panel, and it displays information such as errors and printing status, etc. In the figure, a state is shown in which after printing execution instructions are received, the print job exists internally, and the setting is to offline.

A2. Function Block:

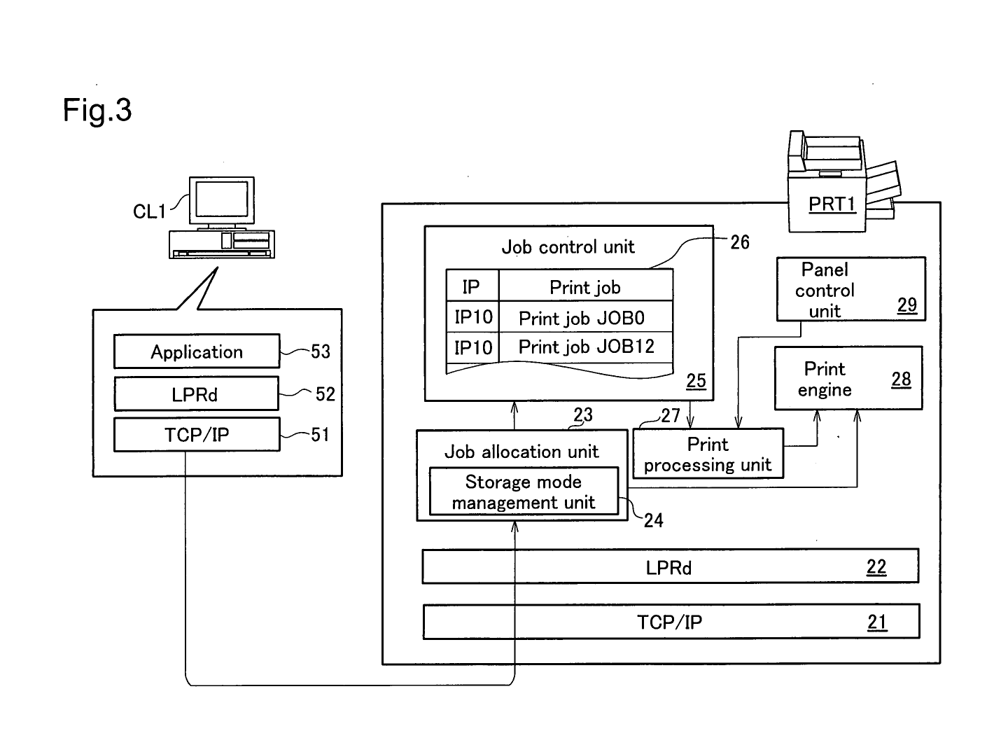

FIG. 3 is an explanatory diagram that shows the function blocks of printer PRT1. Printer PRT1 comprises an internal CPU and a control unit that has memory, and each of the illustrated functional blocks is formed as a software module that implements this control unit.

Having received printing commands from the user, application 53 equipped in client CL1 sends a print job generated according to print protocol LPRd 52 to printer PRT1 through sending unit 52b and TCP/IP 51. Interpretation unit 22 interprets the print protocol LPR and transfers the print job to job allocation unit 23.

Printer PRT1 comprises a TCP/IP 21, interpretation unit 22, job allocation unit 23, storage mode management unit 24, job control unit 25, print job reserve unit 26, print processing unit 27, print engine 28, and panel control unit 29. TCP/IP 21 interprets TCP/IP, and performs communication with the outside via a network. LPRd 22 interprets LPR which is print protocol. Print engine 28 controls each hardware of the printer and executes print jobs. Panel control unit 29 controls the display, displays the printer operating status, and receives contents set by the user.

Storage mode management unit 24 is constructed as part of job allocation unit 23, receives mode switching instructions sent from a client, and manages the IP address of the sending source client of the concerned instructions. Job allocation unit 23 allocates print jobs according to whether the IP address of a received print job is managed by storage mode management unit 24. When the print job send source IP address matches the IP address managed by storage mode management unit 24, the print job is reserved at print job reserve unit 26. When it does not match, it is transferred to print engine 28, and printing is executed normally.

Job control unit 25 stores print jobs transferred from job allocation unit 23 to print job reserve unit 26 set in a designated area of printer PRT1 and reserves printing. After reserving, printing execution instructions are received from a client and the print job stored in print job reserve unit 26 is transferred to print processing unit 27. When the storage mode is set for multiple clients, received print jobs are stored correlated to the IP address of the send source client. When print execution instructions are received from a client, job control unit 25 specifies the print job correlated with the IP address of the instruction send source client from print job reserve unit 26 as a print job to be executed.

Print processing unit 33 performs a process to expand specified print job JOB0 to a printable state, receives notification of detection of panel operation from panel control unit 25, and transfers printing data to print engine 24.

A3. Printing Process:

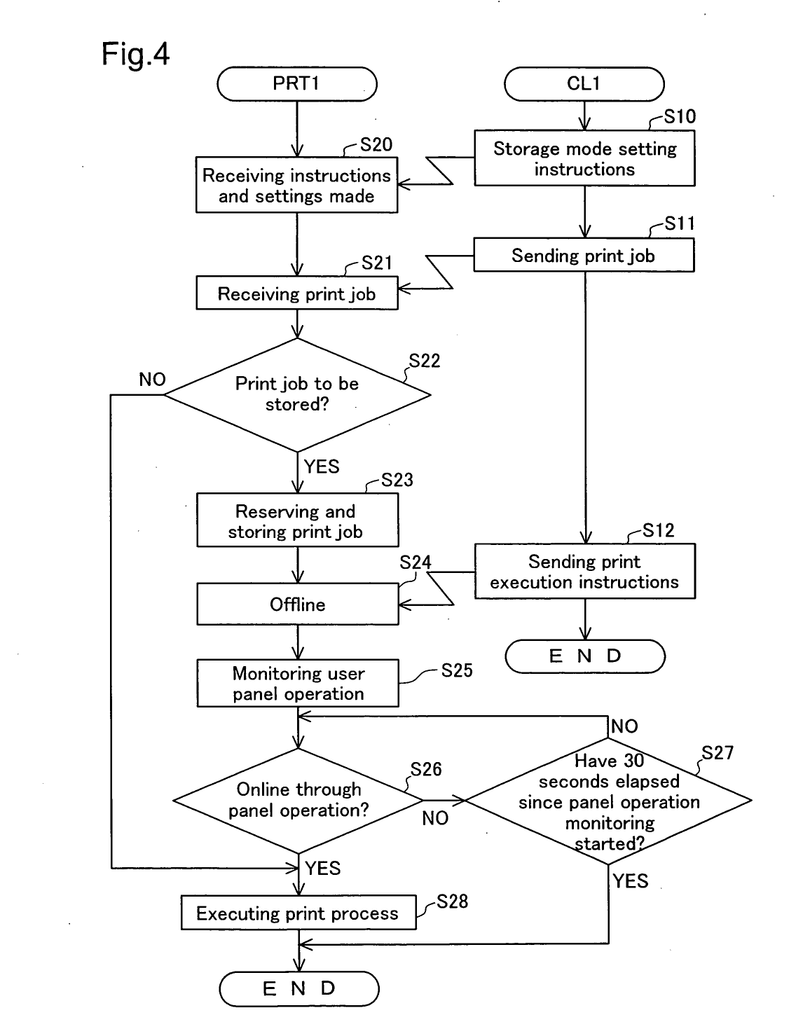

FIG. 4 is a flow chart that explains the printing process of this embodiment. This is the process executed by the control unit of printer PRT1, and the process is started by printer PRT1 receiving storage mode setting instructions from client CL1.

Client CL1 sends storage mode setting instructions to printer PRT1 (step S10) printer PRT1 receives instructions, manages the IP address of client CL1, and sets so that print jobs received thereafter are reserved and stored (step S20). Next, client CL1 sends a print job (step S11) and printer PRT1 receives a print job (step S21).

When printer PRT1 receives a print job (step S21), it judges from the send source IP address of the received print job whether or not the print job is one for which printing should be reserved and storage should be performed (step S22). When it is not a print job to be stored, it waits in the print queue, and following the sequence, printing is executed (step S28).

When this is a print job for which to do print reserve and storage, it is stored in a print job printing reserved state in print job reserve unit 26 (step S23). Then, when printing execution instructions are received from client CL1 (step S24), the operating status goes to offline (step S25).

When printing execution instructions are received, printer PRT1 monitors panel operation by the user (step S25), and judges whether or not this is set to online by the panel operation (step S26). When the operating status is changed to online, the print job is executed (step S28). When no panel operation is detected even after 30 seconds have passed from receiving of the instructions, processing ends without executing printing (step S27). In this case, it is also possible to have the print job cancelled.

A4. Printing Instruction Screen

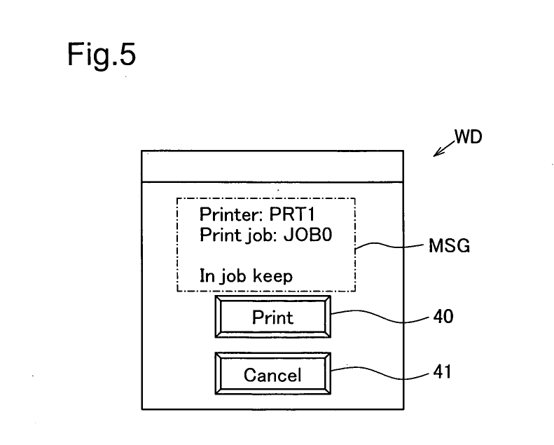

FIG. 5 is an explanatory diagram that shows an example of an instruction screen for sending printing execution instructions. Step S24 (or step S12) of FIG. 4 is the process that is the trigger, and is the screen that is displayed in the display of client CL1. Instruction screen WD comprises message MSG, print button 40, and cancel button 41. Displayed in message MSG are the name of the printer where the print job is reserved, the print job name, and the print job status. With this embodiment, at printer PRT1, print job JOB0 shows a job keep state, in other words, a reserved state.

By pressing print button 40 at the desired timing for printing, the user can send print execution instructions to printer PRT1. When a print job is canceled and printing is stopped, a cancel instruction is sent by pressing cancel button 41.

With the printing device of the first embodiment explained above, with a simple structure, it is possible to reserve execution of a print job between a printer and any client, while at the same time it is possible to execute a print job in a state with the user near the printer, making it possible to avoid stealing or illicit reading, and to improve convenience.

### B. Second Embodiment

With the first embodiment, before sending a print job, mode shifting instructions were sent to the printer from a client. With the second embodiment, the printer is equipped with two ports, and a decision is made whether to reserve printing for each individual port that a print job arrives at.

B1. System Summary:

FIG. 1 is an explanatory diagram that shows the structure of a printing system of a second embodiment. With this embodiment, as shown in the figure, multiple clients CL4 to CL6 and printer PRT10 are connected to a local area network LAN. The IP address of each machine, for purposes of explanation, are set respectively as IP40 to IP60 for clients CL4 to CL6 and as IP2 for printer PR10.

As print job receiving ports, Port 9100 and Port 29100 are equipped on printer PRT10, and print jobs received at Port 9100 are stored in a print queue and printing is performed at the point that its sequential turn comes. Print jobs received at Port 29100, as shown in the figure, are correlated to the IP address of the print job send source client and reserved at print job reserve unit 35.

As shown by the solid line arrow in the figure, clients CL4 to CL6 each send print jobs JOB3 to JOB5 to printer PRT10. In addition to print data to be printed, included in print jobs JOB3 to JOB5 are send source IP addresses 13a to 15a, send destination IP addresses 13b to 15b, and arrival destination port numbers 13c to 15c. Print jobs JOB3 and JOB4 have Port 29100 specified as the arrival destination port number, so on the printer PRT10 side, the jobs are reserved at print job reserve unit 35, and printing is not executed. Print job JOB5 has Port 9100 specified as the arrival destination port number, so on the printer PRT10 side, printing is executed normally.

When the client CL4 user executes printing, it sends printing execution instructions that include its own IP address IP40 to PRT10 as shown by the dotted line in the figure. When printer PRT10 receives print execution instructions, print job JOB3 which has an IP address IP40 is specified as a print job to be printed from the print jobs reserved in print job reserve unit 35, this is analyzed, then expanded to a printable state, and the operating status is set to offline at that time. Printer PRT10 detects that operating panel OP is operated, and the operating status has changed to online, and it then executes print job JOB3.

B2. Function Block:

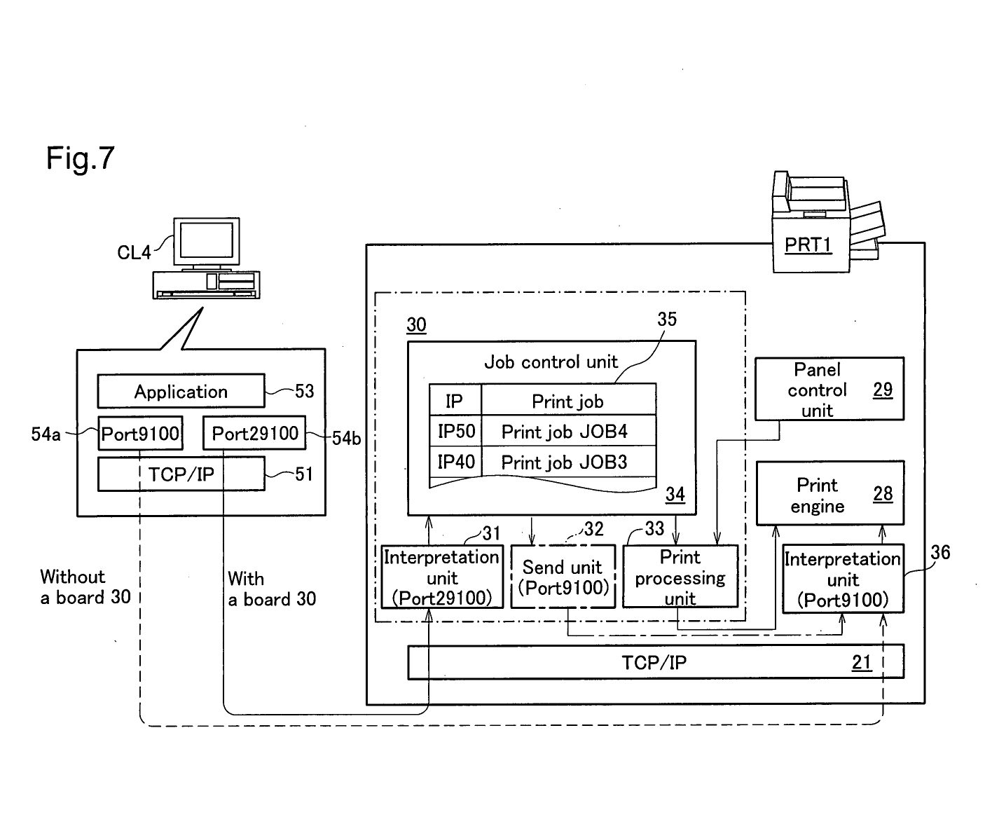

FIG. 7 is an explanatory diagram that shows the functional blocks of printer PRT10. Printer PRT10 is equipped with an internal CPU and a control unit that has memory, and each of the functional blocks shown in the figure are constructed as software modules that this control unit implements. It is also acceptable to construct each of the functional blocks as hardware.

In the figure, the functions originally held by printer PRT10 and the additional functions for realizing print job reserving explained above are shown divided. As functions that were originally held, we list the following blocks. TCP/IP 21 interprets TCP/IP and communicates with the outside via a network. Interpretation unit 36 interprets Port 9100 which is print protocol. Print engine 28 controls each hardware component of the printer and executes the print job. Panel control unit 29 controls the display, displays the printer operating status, and receives the contents set by the user.

When a printer is equipped only with the original functions, print jobs are transferred to printer PRT10 via a path shown by a dotted line in the figure and executed. When a user outputs a print command, application 53 which is equipped in client CL4 sends the print job generated according to print protocol Port 9100 to printer PRT10 through send unit 54a and TCP/IP 51. At printer PRT10, TCP/IP 21 and interpretation unit 36 receive this print job, and after interpreting the protocol, transfer print data to print engine 28.

By installing a port 30 to realize additional functions on this kind of printer, a print job reserve function is realized. Each functional block for the additional functions shown below operates under the control of job control unit 34 for controlling print jobs.

Port 30 comprises interpretation unit 31, send unit 32, print processing unit 33, and job control unit 34. Receiving printing commands from the user, application 53 equipped on client CL4 sends print jobs generated according to print protocol Port 29100 to printer PRT10 through send unit 52b and TCP/IP 51.

Job control unit 34 receives print jobs sent using print protocol Port 29100, correlates this to the IP address IP40 of send source client CL4, and stores this in print job reserve unit 35 which is set in a designated area of printer PRT10 and reserves printing. After reserving, print execution instructions are received from a client on a network, and from the print jobs stored in print job reserve unit 35, a print job correlated to the IP address of the send source of the concerned printing execution instruction is specified and this is transferred to print processing unit 33. When print execution instructions are received from client CL4, job control unit 34 specifies print job JOB3 correlated with IP address IP40 of client CL4 from print job reserve unit 35 as a print job to be printed.

Print processing unit 33 performs processing to expand specified print job JOB3 to a printable state, receives notification of detection of panel operation from panel control unit 29, and transfers print data to print engine 28.

When canceling reserve processing of a print job reserved at printer PRT10 that was generated using the Port 29100 protocol sent from client CL4, and normal printing processing is to be done, realization is possible by regenerating the print job according to print protocol Port 9100 and sending from send unit 32 to interpretation unit 36.

B3. Printing Process:

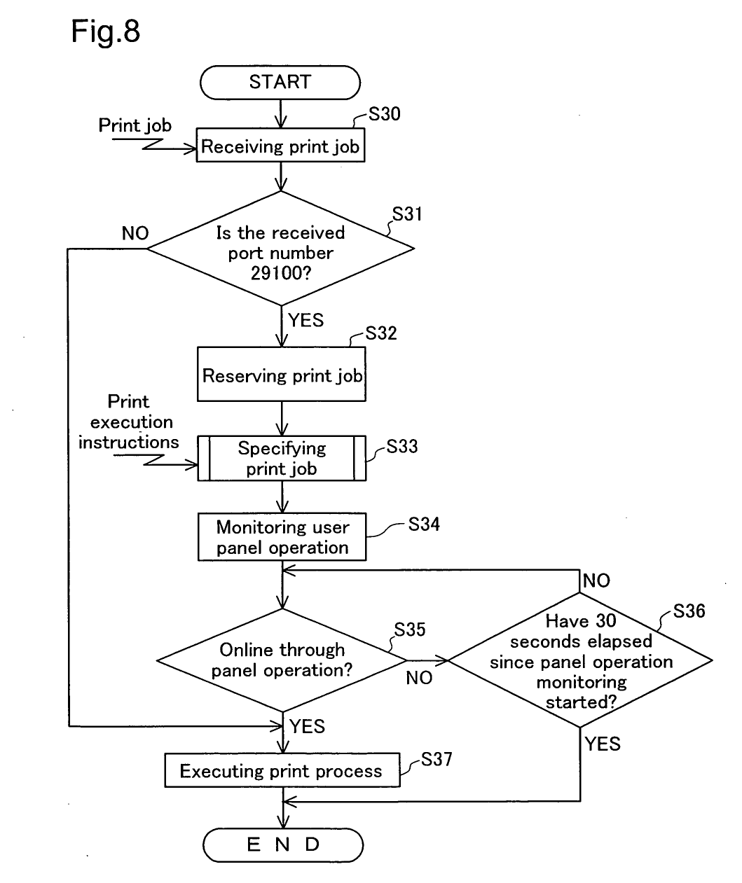

FIG. 8 is a flow chart that explains the print processing of printer PRT10. This is the process executed by the control unit of printer PRT10, and this process starts by printer PRT10 receiving a print job.

When printer PRT10 receives a print job (step S30), a judgment is made of whether the received port number is 29100, in other words, if the print job was generated using the Port 29100 protocol (step S31). When the port number is not 29100, this waits in the print queue, and printing is executed according to sequence (step S37).

When the port number is 29100, the print job is reserved in print job reserve unit 35 (step S32). Then, when print execution instructions are received from a client, the operating status goes offline, and this is specified as a print job to be printed (step S33). Detailed information of the process of specifying a print job will be described later.

When print execution instructions are received, printer PRT10 monitors panel operation by the user (step S34), and judges whether set to online or not by the panel operation (step S35). When the operating status changes to online, the print job is executed (step S37). When panel operation is not detected even after 30 seconds have elapsed from receiving instructions, the process ends without executing the print job (step S36). In this case, it is also possible to cancel the print job.

B4. Print Job Specification Process

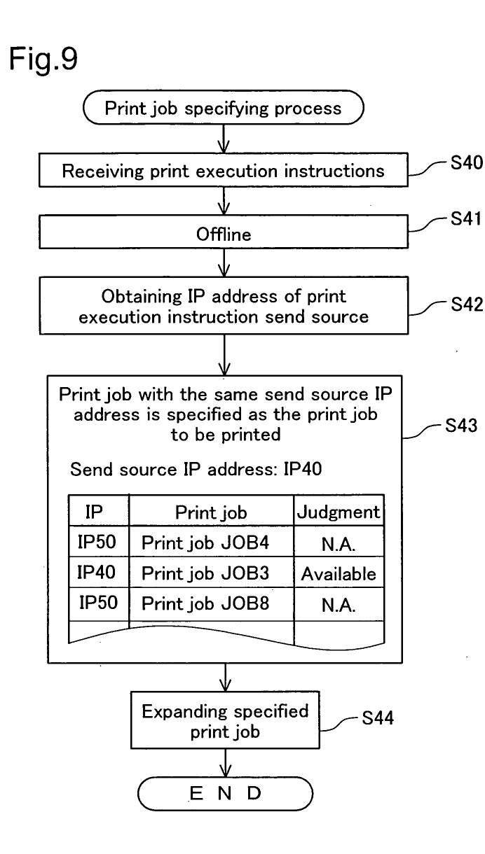

FIG. 9 is a flow chart that explains the process of specifying a print job to be printed. This correlates to the detailed contents of the print job specification process explained above (step S33 in FIG. 8). Following, we will explain the processing contents as implemented by the control unit of printer PRT10.

When printer PRT10 receives print execution instructions from a client (step S40), it sets the operating status to offline (step 41), and gets the IP address as information for specifying the client which sent the print execution instructions (step S42).

Next, a print job sent from the same IP address as the concerned IP address is specified from the print jobs reserved in print job reserve unit 35 (step S43). With this embodiment, as shown in the figure, print job JOB4 received from IP address IP50, print job JOB3 received from IP address IP40, and print job JOB8 received from IP address IP50 are reserved from the top in the received sequence. Since the IP address of the client that sent the print execution instructions is IP40, print job JOB3 is specified as the print job to be printed. Also, for example, when print execution instructions are received from IP address IP50, it is also possible to print both print job JOB4 and print job JOB8 in sequence, or to print only the print job JOB4 which was received first.

Printer PRT10 expands the specified print job JOB3 to a printable state (step S44) and waits. By doing this, when the operating state changes to online by a panel operation, it is possible to execute printing immediately, and to shorten the printing time, which is optimal.

With the printing device of the second embodiment explained above, with a simple structure, it is possible to execute printing in a state with the user near the printer, making it possible to avoid stealing and illicit reading, and to improve convenience.

### C. Third Embodiment

With the second embodiment, a board is installed in a printer to expand the print job reserve function, a print job is sent in advance to a printer, panel operation is detected after print execution instructions are received, and printing is executed. With the third embodiment, the sending of the print job itself will be reserved, and at a printer that is on the same network, the printer that detects a change in operating status by panel operation is specified as the printer to execute the print job, and the print job is sent.

C1. System Summary:

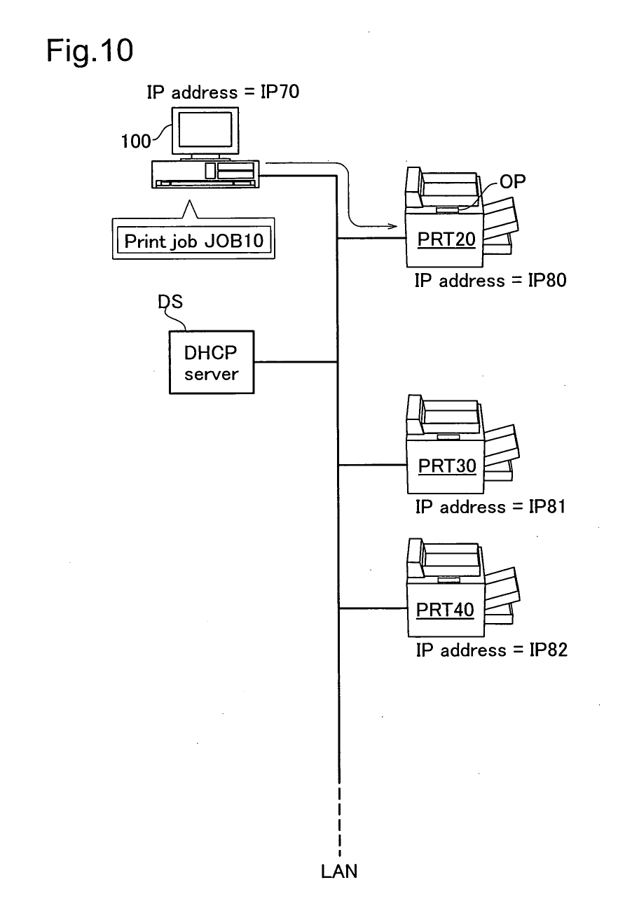

FIG. 10 is an explanatory diagram that shows the structure of a printing system as a third embodiment. As shown in the figure, with this embodiment, client 100 and multiple printers PRT10 to PRT40 are connected to a local area network LAN. The IP address of each machine is allocated by a DHCP server DS installed on the LAN. For explanatory purposes, the address IP70 is set for client 100, and the addresses IP80 to IP82 are respectively set for printers PRT20 to PRT40.

At client 100, a print control device that controls print processing is constructed, and the concerned print control device performs processing as explained hereafter (hereafter, client 100 will be called print control device 100). Print control device 100 receives printing instructions from the user and reserves sending of the print job. Also, at printers PRT10 to PRT30 that are on the same network, the printer that detects changes in operating status by panel operation is specified as the printer to execute a print job, and the print job is sent. With this embodiment, as shown in the figure, after receiving printing instructions, the print control device reserves sending of print job JOB10, and at printer PRT10, after receiving notification of a change in operating status from offline to online by a panel operation, it sends print job JOB10 to printer PRT10.

Operating panel OP of printer PRT10 is the same as operating panel OP of the first embodiment.

C2. Function Block:

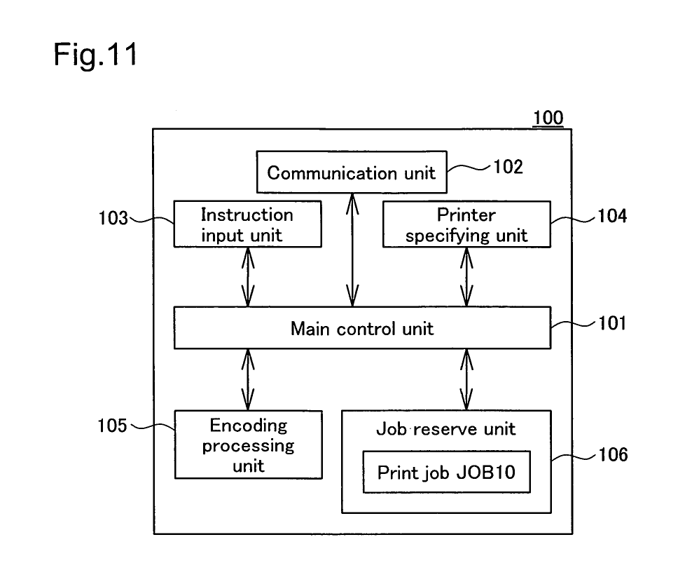

FIG. 11 is an explanatory diagram that shows the functional blocks of print control device 100. Print control device 100 comprises a main control unit 101, communication unit 102, instruction input unit 103, printer specification unit 104, encoding processing unit 105, and job reserve unit 106. The main control unit exhibits a function of controlling each function block. Communication unit 102 receives information from outside, and instruction input unit 103 inputs instructions such as printing by the user.

Job reserve unit 106 receives printing instructions via instruction input unit 103, and reserves print job JOB10 to be printed without sending it to the printer. Printer specification unit 104 extracts the printers that will fulfill the printing specifications based on the printing requirements of print job JOB10 from the printers that are on the same network as print control device 100, and from these printers, specifies the printer which has been notified of a change in operating status as the print job sending destination. Encoding processing unit 105 gives notice of the change in operating status and at the same time receives an encoding key for encoding print job JOB10, and using the concerned encoding key, encodes print job JOB10, and sends this to the printer. With this embodiment, a public key encoding method is used, and the encoding key is shown as a public key generated on the printer side. It is also possible to have the user decide as desired whether or not to perform encoding processing.

C3. Print Control Device Side Printing Process:

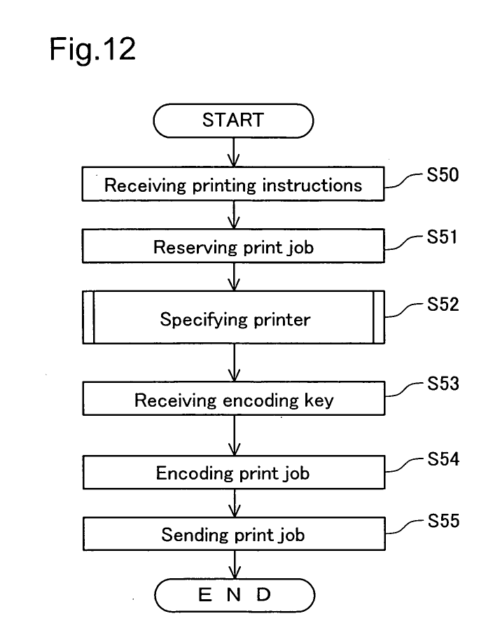

FIG. 12 is a flow chart that explains the printing process of print control device 100 for this working embodiment. This is the process by which main control unit 101 controls each function block, and this process starts by printing instructions from the user.

Print control device 100 receives printing instructions from the user (step S50), reserves the print job (step S51), and from printers on the same network, specifies the printer to which to send the print job (step S52). The concerned process will be described later.

Next, an encoding key for encoding the print job from a specified printer is received (step S53), encoding processing is performed on the print job using the concerned encoding key (step S54), and the print job is sent to the specified printer (step S55). When not performing encoding processing, it is possible to omit steps S53 and S54.

C4. Printer Specification Process:

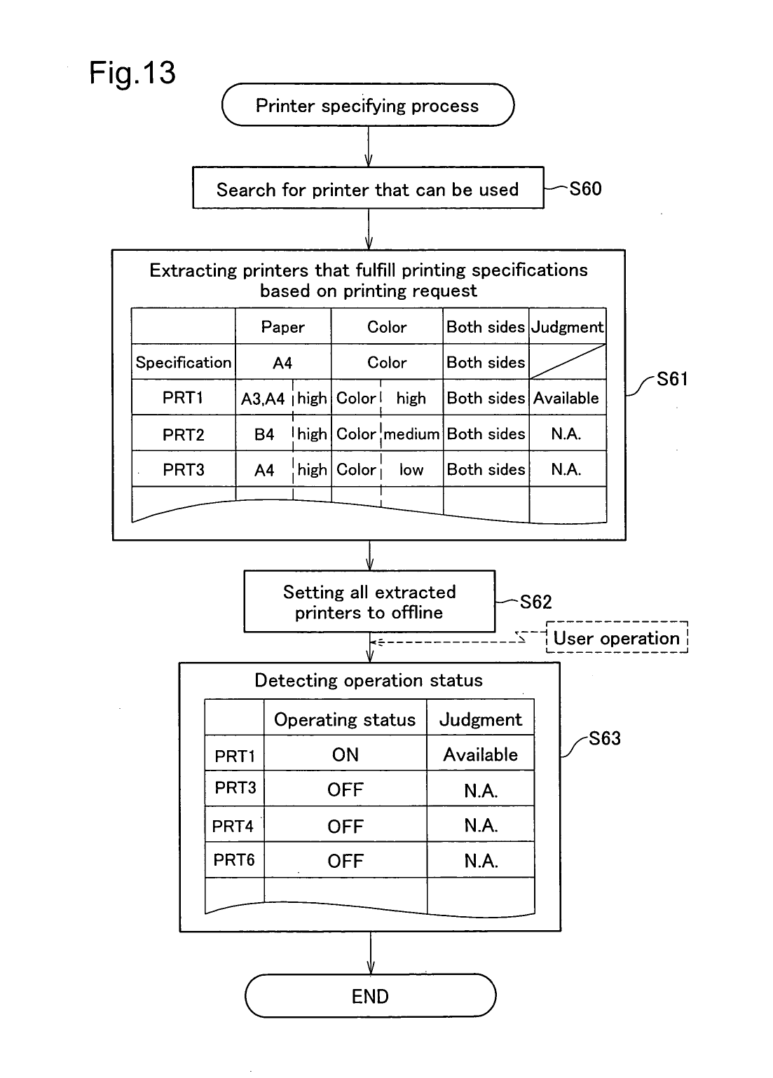

FIG. 13 is a flow chart that explains the printer specification process for this embodiment. This correlates to the detailed contents of the printer specification process explained above (step S52 in FIG. 12). Following, we will explain the processing contents for main control unit 101 of print control device 100 performing control of each functional block.

First, print control device 100 searches for a usable printer among the printers on the network (step S60). For example, it is possible to search by inquiring about operating status by broadcasting using an SNMP in relation to the printers on the network, and for example, it can be judged that a printer is unusable, etc. if an error occurs.

Next, print control device 100 extracts the printers that fulfill the printing specifications specified by the print job (step S61). An example of the printing specifications is shown in the figure. For example, printing specifications include things like print paper size, color or black and white, and whether both sided printing is required. Each printing device specification can also be inquired about using an SNMP. With this embodiment, we are having an inquiry made about consumables such as printing paper and ink together with the remaining amounts.

As shown in the figure, with the printing specifications, A4 size paper, color printing, and both sided printing are specified. For each of these items, the inquiry results of the found printers PRT1, PRT2, and PRT3 are as shown in the figure. Printer PRT1 is capable of printing to A3 size and A4 size paper, color printing, and both sided printing, and the paper and ink remaining volumes are “high,” so this fulfills all of the specifications, and it is judged to be “Available,” in other words, to be a printer that is a candidate to send to.

Also, printer PRT2 can only handle B4 size paper, so it does not fulfill the printing specifications. Also, printer PRT3 has a low remaining amount of ink, so it does not fulfill the printing specifications. Therefore, these printers are judged to be N.A. (Not Available, in other words, not to be printers that are candidates to send to.

For the judgment about the remaining volume of consumable items, it is possible to perform this by comparing with a designated reference value set in advance, or to consider the specification contents of the print job. For example, when printing of 100 copies is specified, it is possible to evaluate the remaining volume of paper with 100 sheets as a standard. For the remaining volume, for example, it is possible to use the data volume of the printing data as the reference, calculate the anticipated ink remaining volume, and evaluate from this. It is also possible to perform printer extraction without considering the remaining volume of consumable items, but by considering the remaining volume, there is the advantage of being able to avoid errors due to insufficient consumable items midway during printing. Especially when printing a large number of pages or copies, it is possible to suppress confusion about understanding the number of copies due to errors.

In this way, the operating status of all the extracted printers is unified online (step S62). As a method of unification, for example, setting can be done by adding offline setting information to an SNMP packet and then broadcasting. It is also possible to do a unicast of SNMP packets individually for each printer. As shown by the dotted line in the figure, a user that sends a print job from client 100 goes to the printer he wants to use as the sending destination, and sets to online manually.

Printer PRT1 is a distribution destination candidate printer judged to be “Available” at step S61, and a printer for which the operating status is changed from offline to online is specified as a substitute printer (step S63). This change is performed within 30 seconds after setting to offline. An example of the printer operating status is shown in the figure. With this example, at step S61, there are four printers judged to be candidate printers, PRT1, PRT3, PRT4, and PRT6. Printer PRT1 reflects the fact that it was set to online by the user, and since the operating status is On, it is judged to be “Available,” in other words, to be suitable as a send destination printer. Printers PRT3, PRT4, and PRT6 are still offline, so are judged to be N.A., in other words, not suitable as send destination printers. After specifying the send destination printer, all printers that are offline are set to online, and by doing this, the printers other than the send destination printer can be used normally, which is optimal. In this case, for example, the same as when set to offline, setting can be done easily by adding online setting information to an SNMP packet and broadcasting. It is also possible to do a unicast of an SNMP packet to each individual printer.

The send destination printer is specified by the process above. With specification of the send destination printer, it is permissible to omit part of the various conditions considered with this embodiment.

C5. Printer Side Printing Process:

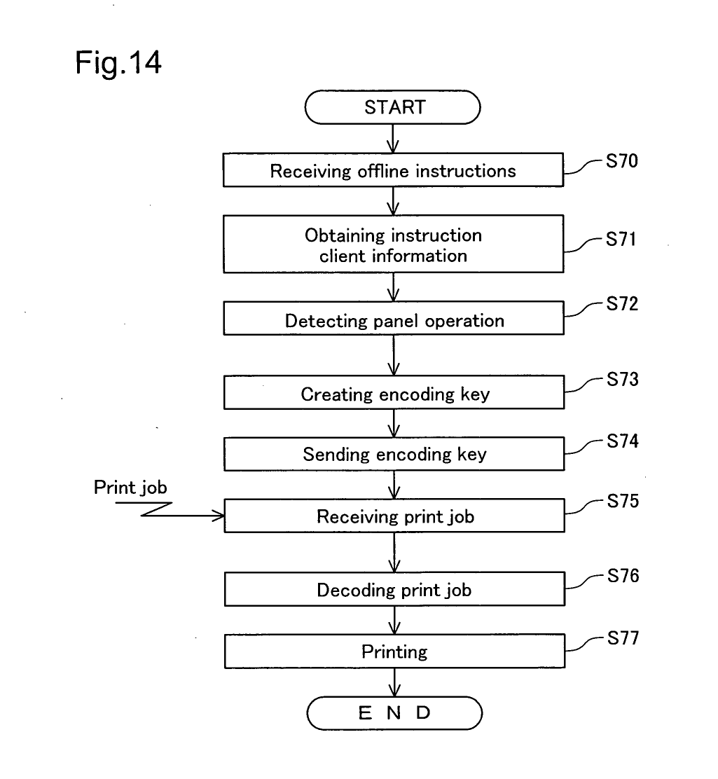

FIG. 14 is a flow chart that explains the printing process of printer PRT20 for this embodiment. This is the process of receiving instructions at step S62 of FIG. 13 and starting printer PRT20.

The instructions to set the operating status to offline are received from print control device 100 and this is set to offline (step S70), and at the same time, the IP address is fetched that specifies the client that sent the concerned instructions. With this embodiment, client 100 sends printing instructions to printer PRT20, so it gets IP address IP80 (step S71).

Next, operation of the operating panel OP by the user is detected (step S72), and an encoding key for performing encoding processing is generated (step S74). With this embodiment, we used a public key encoding method, so a public key for printer PRT1 to encode the print job and a secret key for decoding are generated.

The public key is sent to IP address IP70 (step S74) which was fetched at step S71. At print control device 100, the processes of steps S53 to S55 in FIG. 12 are performed, and the encoded print job is sent. Printer PRT20 receives the print receives print job encoded this way with a public key (step S75). The received encoded print job is decoded using the secret key (step S76), and printing is executed (step S77).

With the printing control device of the third embodiment as explained above, it is possible to send a print job and execute printing at the desired timing of the user to a desired printing device, in a state whereby the user is near the user, so this increases convenience.

With the third embodiment described above, we had a print job sent only to one printer, but it is also possible to perform operations on multiple printers, to send print jobs to all the printers on which an operation was performed, and to realize parallel printing. In this case, from the perspective of security of the output printed items, it is desirable to have the printers that perform parallel printing be located close to each other.

Also, when not performing encoding processing, it is possible to omit steps S73 to S74 as well as S76.

### C. Other Embodiments

Above, we explained various embodiments of the present invention, but the present invention is not limited to these embodiments, and it is obvious that it is possible to use various structures without straying from the gist of the invention. For example, a structure such as the following is possible. For example, this is not limited to printing devices, and can be used for various other output devices such as a projector, a display, or acoustic equipment.

Also, as the print job issuing device, for example, a machine that exhibits the function of sending a print job to a printing device such as a client computer or a print server connected to a network can be used. It is also possible to use a mobile terminal, etc. Also, as the machine specification information that can specify the concerned print job issuing device, for example, it is possible to use various information such as the IP address allocated to each machine, a preset MAC address, or a number set as desired to each machine. The user operation does not have to be a remote operation via a network, but for example, can be various operations performed directly on the printing device itself such as a printing device panel operation, removing or setting of the paper cassette, or the operation of opening and closing the cover, etc.

(1) With the third embodiment of the present invention, the actual sending of the print job itself is reserved, and the print job was sent by notification of a change in printer operating status, but the invention is not limited to this. For example, it is also possible to send a print job in advance to the desired printer for printing, and to send print execution instructions using notification of changes in the printer operating status.

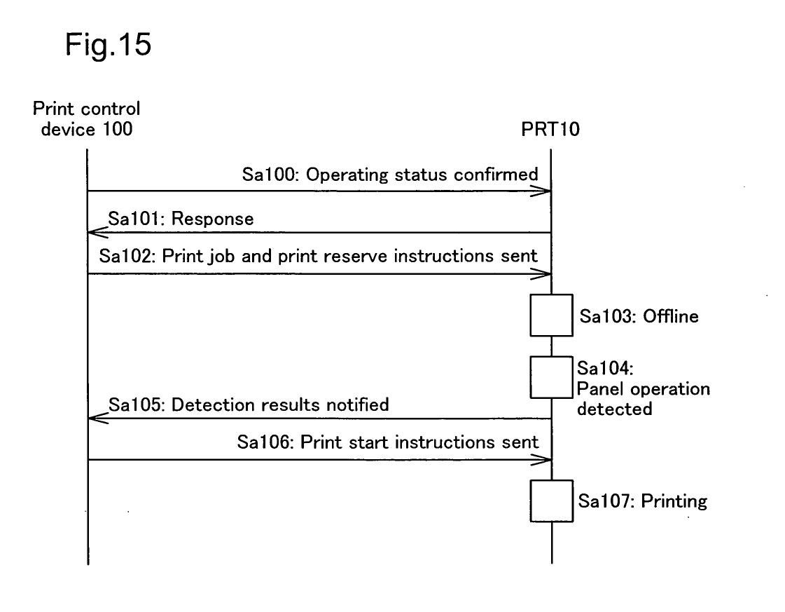

FIG. 15 is a flow chart that explains the printing process of the variation example. The system overview is the same as that of the third embodiment. Print control device 100 sends a signal confirming the operating status to the desired printer PRT20 for printing (step Sa100). Printer PRT20 sends the operating status as a response to the concerned signal (step Sa101). As operating status, for example, there is the online/offline status, error occurrence, and whether or not there is a job waiting to be printed, etc.

Print control device 100 judges whether printing is possible based on the response from printer PRT20, and when it is possible, together with sending the print job, it also sends print reserve instructions to reserve printing (step Sa102). When printer PRT20 receives print reserve instructions, it reserves the print job, and sets the operating status to offline (step Sa103).

After sending the print job, the user moves to near printer PRT20, and by doing panel operation, changes the operating status of printer PRT20 from offline to online. Printer PRT20 detects the concerned panel operation (step Sa104), and notifies the detection results to print control device 100 (step Sa105).

When it receives the detection result notification, print control device 100 sends to printer PRT20 instructions to cancel the print job reserve and to start printing (step Sa106). Printer PRT20 receives the concerned print start instructions and starts printing (step Sa107).

By doing this, the user can send the print job to the desired printer for printing, and can perform printing by performing a printer panel operation, and can thus avoid things like stealing of the output printed item.

(2) With the embodiment described above, detection of changes in the printer operating status was done using switching from offline to online, but the invention is not limited to this, and, for example, it is also possible to detect using various aspects such as the status changes of opening and closing of the printer cover, setting of the paper cassette, and switching from online to offline or offline to online.

(3) With the embodiment described above, the timing of starting the printing of a print job was determined by a printer panel operation, but, for example, it is also possible to apply this in a case such as when performing initial settings with a printer placed in a position that is easy to use for the user as the printer for to be printed with top priority from the multiple printers on the same network.

Also, for example, when creating a network topology that shows placement of network machines in an office, it is possible to perform printer placement and detailed settings, etc. by specifying the position a printer is placed at by a click, etc. and after that, as with the present invention, by performing a printer panel operation.

1. An output device which is an output device that executes output processing using data received from a data sending device connected to a network, the output device comprising:
a data receiving unit that receives said data from said data sending device;
a reserve unit that reserves said data in a state whereby said data sending device is correlated to specifiable device specification information;
an instruction receiving unit that receives execution instructions including said machine specification information from said data sending device;
a data specification unit that specifies data to be output from said reserved data based on said device specification information;
a detection unit that detects user operations on said output device after receiving said execution instructions; and
an output unit that executes output processing using said specified data based on said operation detection.

2. A printing device which is a printing device that executes print jobs received from a print job issuing device connected to a network, wherein the printing device comprises:
a job receiving unit that receives said print jobs from said print job issuing device;
a print reserve unit that reserves said print jobs in a state whereby said print job issuing device is correlated to specifiable device specification information;
an instruction receiving unit that receives execution instructions including said device specification information from said print job issuing device;
a print job specification unit that specifies a print job to be executed from said reserved reserve print jobs based on said device specification information;
a detection unit that detects user operations on said printing device after receiving said execution instructions; and
a print execution unit that executes said specified print jobs based on said operation detection.

3. A printing device of claim 1 further comprising:
a mode instruction receiving unit that receives from said job issuing device mode instructions that reserve execution of said received print job and specify a storage mode for storing said printing jobs; and
a mode control unit that operates said print reserve unit, said instruction receiving unit, said print job specification unit, said detection unit, and said print execution unit for print jobs sent from said print job issuing device after receiving said mode instructions.

4. A printing device of claim 2 wherein said detection unit performs said operation detection for a designated time.

5. A printing device of claim 2 further comprising:
a print processing unit that expands and reserves said specified print job to data for which printing can start regardless of said operation detection.

6. A printing device of any one of claims 2 through 5 wherein said instruction receiving unit further sets the operating status of said printing device to offline after receiving said execution instructions.

7. A printing device of claim 6 wherein said instruction receiving unit rejects said execution instructions from after said execution instructions are received until said operation is detected.

8. An output control device that controls an output device connected to a network, the output control device comprising:
a reserve unit for reserving output processes using said data based on output instructions from the user;
a detection unit that detects changes in the operating status based on said user operation in relation to said output device; and
an instruction unit that sends execution instructions for having said output process executed based on said change detection.

9. A print control device that controls execution of print jobs at a printing device connected to a network, the print control device comprising:
a reserve unit for reserving execution of said print jobs based on printing instructions from the user;
a detection unit that detects changes in the operating status based on said user operation in relation to said printing device; and
a print instruction unit that sends execution instructions for executing said print jobs based on said change detection.

10. A printing device of claim 9 wherein said detection unit performs said detection of changes in operating status for a designated time.

11. A print control device of claim 9 wherein said reserve unit sends to said printing device said print jobs and print reserve instructions for reserving execution of said print jobs.

12. A print control device of claim 11 wherein said print reserve instructions are instructions that set the operating status of said printing device to offline after receiving said print jobs.

13. A print control device of claim 9 wherein said reserve unit reserves sending of said print jobs, and said print instruction unit sends said print jobs as said execution instructions.

14. A print control device of any of claims 9 through 13 further comprising:
an encoding processing unit that encodes said print jobs and sends the encoded print jobs to said printing device.

15. An output method that outputs data received from another device that is connected to a network, the output method comprising:
receiving said data from said other device;
reserving said data in a state whereby said other device is correlated to specifiable device specification information;
receiving execution instructions including said device specification information from said other device;
specifying data for which output processing is to be executed from said reserved data based on said device specification information;
detecting user operation on said output device after receiving said execution instructions; and
executing output processing of said specified data based on said operation detection.

16. A printing method that prints print jobs received from another device connected to a network, the printing method comprising:
receiving said print job from said other device;
reserving said print job in a state whereby said other device is correlated to specifiable device specification information;
receiving execution instructions including said device specification information from said other device;
specifying a print job to be printed from said reserved print jobs based on said device specification information;
detecting user operation after receiving said execution instructions; and
executing said specified print job based on said operation detection.

17. An output control method that controls an output device connected to a network, the output control method comprising:
reserving output of said data based on output instructions from the user;
detecting changes in operating status based on said user operation on said output device; and
sending execution instructions to have output processing executed using said data based on said change detection.

18. A print control method that performs printing of print jobs using a printing device connected to a network, the print control method comprising:
obtaining the operating status of said printing device;
reserving execution of printing of said print job based on printing instructions from the user;
detecting changes in operating status based on said user operation on said printing device; and
sending execution instructions to have said print job executed based on said change detection.

19. A computer readable recording medium that stores a computer program executed by a computer to control an output device that outputs data received from another machine connected to a network, said computer program comprising:
a program command to receive said data from said other device;
a program command to reserve said data in a state whereby said other device is correlated to specifiable device specification information;
a program command to receive execution instructions including said machine specification information from said other device;
a program command to specify data to be used for output processing from said reserved data based on said device specification information;
a program command to detect user operation after receiving said execution instructions; and
a program command to execute output processing of said specified data based on said operation detection.

20. A computer readable recording medium that stores a computer program executed by a computer to control a printing device that prints print jobs received from other machines connected to a network, said computer program comprising:
a program command to receive said print jobs from said other device;
a program command to reserve said print jobs in a state whereby said other device is correlated to specifiable device specification information;
a program command to receive execution instructions including said device specification information from said other device;
a program command to specify print jobs to be executed from said reserved print jobs based on said device specification information;
a program command to detect user operation on said printing device after receiving said execution instructions; and
a program command to execute said specified print job based on said operation detection.

21. A computer readable recording medium that stores a computer program executed by a computer for controlling an output device connected to a network, said computer program comprising:
a program command to reserve said data output processing based on output instructions from the user;
a program command to detect changes in operating status based on said user operation in relation to said output device; and
a program command to send execution instructions to have said output processing executed based on said change detections.

22. A computer readable recording medium that stores a computer program executed by a computer for controlling the printing of a printing job between devices connected to a network, said computer program comprising:
a program command to reserve execution of said print job based on printing instructions from the user;
a program command to detect changes in operating status based on said user operation in relation to said printing device; and
a program command to send execution instructions to have said print job executed based on said change detection.
